(19) United States
(12) Patent Application Publication
(10) Pub. No.: US 2026/0358097 A1
(43) Pub. Date: Nov. 12, 2026

(54) BALLISTIC RESISTANT ARMOR AND METHOD OF MAKING THE SAME

(71) Applicant: A. M. Armory, LLC, Dublin, OH (US)

(72) Inventors: Jared D Crooks, Powell, OH (US); Thomas Y Kendrick, Dresden, OH (US)

(21) Appl. No.: 19/125,736

(22) PCT Filed: Oct. 30, 2023
(86) PCT No.: PCT/US2023/078259

§ 371 Date: Apr. 30, 2025

Related U.S. Application Data
(60) Provisional application No. 63/381,569, filed on Oct. 30, 2022.
(60) Provisional application No. 63/383,940, filed on Nov. 16, 2022.

(51) Int. Cl. F41H 5/04

(52) U.S. Cl. CPC F41H 5/0492

(57) ABSTRACT

In one aspect, a ballistic armor is provided, comprising: a front and a back; one or more ballistic tile; one or more insert between the ballistic tile and the back; and a polymer encapsulating the one or more ballistic tile and the one or more insert; wherein one or more mold tab is attached to an edge of one or more ballistic tile. In another aspect, a ballistic armor is provided, comprising: a front and a back; an inner housing formed from a polymer, wherein the inner housing includes one or more tooling tab; one or more ballistic tile mounted to a mounting area of the inner housing between the inner housing and the front; one or more insert mounted to the inner housing between the inner housing and the back; and a polymer encapsulating the one or more ballistic tile and the one or more insert.

### CROSS-REFERENCE TO RELATED APPLICATIONS

This application claims priority from U.S. Provisional Patent Application No. 63/381,569 filed on Oct. 30, 2022, and U.S. Provisional Patent Application No. 63/383,940 filed on Nov. 16, 2022, each of which is incorporated by reference herein in its entirety.

### BACKGROUND

Ballistic armor, such as that used to stop high velocity rifle bullets, shrapnel, knives, and the like, is typically formed from hardened materials such as steel or ceramic, in flat sheets with limited contour. However, it is difficult to form these materials with contours and bending materials like steel result in weakening of the steel.

What is needed is a ballistic armor that can be easily formed in a variety of complex shapes, contours, curves, and the like, without weakening the ballistic armor.

### SUMMARY

In one aspect, a ballistic armor is provided, the ballistic armor comprising: a front and a back; one or more ballistic tile; one or more insert between the ballistic tile and the back; and a polymer encapsulating the one or more ballistic tile and the one or more insert; wherein one or more mold tab is attached to an edge of one or more ballistic tile.

In another aspect, a ballistic armor is provided, the ballistic armor comprising: a front and a back; an inner housing formed from a polymer, wherein the inner housing includes one or more tooling tab; one or more ballistic tile mounted to a mounting area of the inner housing between the inner housing and the front; one or more insert mounted to the inner housing between the inner housing and the back; and a polymer encapsulating the one or more ballistic tile and the one or more insert.

### BRIEF DESCRIPTION OF THE FIGURES

The accompanying figures, which are incorporated in and constitute a part of the specification, illustrate various example configurations, and are used merely to illustrate various example embodiments. In the figures, like elements bear like reference numerals.

FIG. 1A illustrates a plan view of an array 102 of ballistic tiles 104.

FIG. 1B illustrates a perspective view of array 102 of ballistic tiles 104.

FIG. 2A illustrates a plan view of stacked arrays 202A, 202B of ballistic tiles 204A, 204B.

FIG. 2B illustrates an elevation view of stacked arrays 202A, 202B of ballistic tiles 204A, 204B.

FIG. 2C illustrates a perspective view of stacked arrays 202A, 202B of ballistic tiles 204A, 204B.

FIG. 3A illustrates an elevation view of a ballistic armor 300 formed from stacked arrays 302A, 302B of ballistic tiles 304A, 304B encapsulated in a polymer 310.

FIG. 3B illustrates a plan view of ballistic armor 300 formed from stacked arrays of ballistic tiles 304A, 304B encapsulated in polymer 310.

FIG. 3C illustrates a perspective view of ballistic armor 300 formed from stacked arrays of ballistic tiles 304A, 304B encapsulated in polymer 310.

FIG. 4A illustrates a perspective view of a ballistic armor 400 formed from array 402 of ballistic tiles 404 encapsulated in a polymer 410.

FIG. 4B illustrates a perspective view of ballistic armor 400 formed from array 402 of ballistic tiles 404 encapsulated in a polymer 410.

FIG. 5A illustrates a perspective view of a ballistic armor 500 formed from array 502A of ballistic tiles 504A encapsulated in polymer 510A to be bonded to array 502B of ballistic tiles 504B encapsulated in polymer 510B.

FIG. 5B illustrates a perspective view of ballistic armor 500 formed from array 502A of ballistic tiles 504A encapsulated in polymer 510A to be bonded to array 502B of ballistic tiles 504B encapsulated in polymer 510B.

FIG. 5C illustrates an elevation view of ballistic armor 500 formed from array 502A of ballistic tiles 504A encapsulated in polymer 510A to be bonded to array 502B of ballistic tiles 504B encapsulated in polymer 510B.

FIG. 5D illustrates a perspective view of ballistic armor 500 formed from array 502A of ballistic tiles 504A encapsulated in polymer 510A to be bonded to array 502B of ballistic tiles 504B encapsulated in polymer 510B.

FIG. 6A illustrates an elevation view of ballistic armor 600 formed from stacked arrays 602A, 602B encapsulated in a polymer 610, including an insert 620.

FIG. 6B illustrates an elevation view of ballistic armor 600 formed from stacked arrays 602A, 602B encapsulated in polymer 610, including insert 620.

FIG. 6C illustrates an elevation view of ballistic armor 600 formed from stacked arrays 602A, 602B encapsulated in polymer 610, including a plurality of inserts 620.

FIG. 6D illustrates an elevation view of ballistic armor 600 formed from stacked arrays 602A, 602B encapsulated in polymer 610, including a plurality of inserts 620.

FIG. 6E illustrates an elevation view of ballistic armor 600 formed from stacked arrays 602A, 602B encapsulated in polymer 610, including an insert 620.

FIG. 6F illustrates an elevation view of ballistic armor 600 formed from a single array 602B encapsulated in polymer 610, including an insert 620.

FIG. 6G illustrates an elevation view of ballistic armor 600 formed from stacked arrays 602A, 602B encapsulated in polymer 610, including a plurality of inserts 620, encountering a projectile 630.

FIG. 7 illustrates an elevation view of stacked arrays 702A, 702B encountering a projectile 730.

FIG. 8A illustrates a perspective view of a triangular ballistic tile 804 having a stepped edge 840.

FIG. 8B illustrates a plan view of array 802 of triangular ballistic tiles 804 having stepped edge 840.

FIG. 8C illustrates an elevation view of array 802 of triangular ballistic tiles 804 having stepped edge 840.

FIG. 8D illustrates a sectional view of array 802 of triangular ballistic tiles 804 having stepped edge 840.

FIG. 9A illustrates a perspective view of an array 902 of square ballistic tiles 904 having a stepped edge 940.

FIG. 9B illustrates a perspective view of array 902 of square ballistic tiles 904 having stepped edge 940.

FIG. 9C illustrates an elevation view of ballistic armor 900 of square ballistic tiles 904 encapsulated in a polymer 910, encountering a projectile 930.

FIG. 9D illustrates an elevation view of ballistic armor 900 of square ballistic tiles 904 encapsulated in a polymer 910, encountering a projectile 930.

FIG. 9E illustrates a perspective view of array 902 of square ballistic tiles 904 having stepped edge 940.

FIG. 9F illustrates an elevation view of array 902 of square ballistic tiles 904 having stepped edge 940, encountering a projectile 930.

FIG. 9G illustrates an elevation view of array 902 of square ballistic tiles 904 having stepped edge 940, encountering a projectile 930.

FIG. 9H illustrates an elevation view of array 902 of square ballistic tiles 904 having stepped edge 940, encountering a projectile 930.

FIG. 9I illustrates an elevation view of ballistic armor 900 of square ballistic tiles 904 encapsulated in a polymer 910, encountering a projectile 930.

FIG. 10A illustrates a perspective view of a square ballistic tile 1004 having an angled edge 1042.

FIG. 10B illustrates a top plan view of square ballistic tile 1004 having angled edge 1042.

FIG. 10C illustrates a bottom plan view of square ballistic tile 1004 having angled edge 1042.

FIG. 10D illustrates a perspective view of an array 1002 of square ballistic tiles 1004 having angled edge 1042.

FIG. 10E illustrates a perspective view of an array 1002 of square ballistic tiles 1004 having angled edge 1042.

FIG. 10F illustrates a perspective view of an array 1002 of square ballistic tiles 1004 having angled edge 1042.

FIG. 10G illustrates a perspective view of an array 1002 of square ballistic tiles 1004 having angled edge 1042.

FIG. 10H illustrates a perspective view of an array 1002 of square ballistic tiles 1004 having angled edge 1042, encountering a projectile 1030.

FIG. 10I illustrates a perspective view of an array 1002 of square ballistic tiles 1004 having angled edge 1042, encountering a projectile 1030.

FIG. 10J illustrates a perspective view of an array 1002 of square ballistic tiles 1004 having angled edge 1042, encountering a projectile 1030.

FIG. 10K illustrates a perspective view of an array 1002 of square ballistic tiles 1004 having angled edge 1042, encountering a projectile 1030.

FIG. 10L illustrates a perspective view of ballistic armor 1000 of square ballistic tiles 1004 encapsulated in a polymer 1010, encountering a projectile 1030.

FIG. 11A illustrates a perspective view of a triangular ballistic tile 1104 having an angled edge 1142.

FIG. 11B illustrates a bottom plan view of triangular ballistic tile 1104 having angled edge 1142.

FIG. 11C illustrates a top plan view of triangular ballistic tile 1104 having angled edge 1142.

FIG. 11D illustrates a perspective view of an array 1102 of triangular ballistic tiles 1104 having angled edge 1142.

FIG. 11E illustrates a perspective view of array 1102 of triangular ballistic tiles 1104 having angled edge 1142.

FIG. 11F illustrates a perspective view of array 1102 of triangular ballistic tiles 1104 having angled edge 1142, encountering a projectile 1130.

FIG. 12A illustrates a perspective view of an array 1202 of hexagonal ballistic tiles 1204 and parallelogram ballistic tiles 1244, having stepped edges 1240.

FIG. 12B illustrates a perspective view of array 1202 of hexagonal ballistic tiles 1204 and parallelogram ballistic tiles 1244, having stepped edges 1240.

FIG. 13A illustrates a perspective view of a ballistic foam 1304 having a plurality of pores 1346.

FIG. 13B illustrates a perspective view of ballistic foam 1304 having a plurality of pores 1346, encountering a projectile 1330.

FIG. 13C illustrates a perspective view of ballistic foam 1304 having a plurality of pores 1346 filled with and encapsulated in a polymer 1310, encountering a projectile 1330.

FIG. 14A illustrates a perspective view of a hexagonal ballistic tile 1404 having an angled edge 1442.

FIG. 14B illustrates a plan view of hexagonal ballistic tile 1404 having angled edge 1442.

FIG. 15A illustrates a perspective view of a hexagonal ballistic tile 1504 having an angled edge 1542.

FIG. 15B illustrates a plan view of hexagonal ballistic tile 1504 having angled edge 1542.

FIG. 16A illustrates a perspective view of a hexagonal ballistic tile 1604 having a stepped edge 1640.

FIG. 16B illustrates a plan view of hexagonal ballistic tile 1604 having a stepped edge 1640.

FIG. 17A illustrates a perspective view of ballistic armor 1700 including a perforated plate 1748 encapsulated in a polymer 1710.

FIG. 17B illustrates a perspective view of ballistic armor 1700 including perforated plate 1748 and an insert 1720, all encapsulated in polymer 1710.

FIG. 17C illustrates a perspective view of ballistic armor 1700 including perforated plate 1748, insert 1720, and an array 1702 of ballistic tiles 1704, all encapsulated in polymer 1710.

FIG. 18A illustrates a front perspective view of a ballistic armor 1800.

FIG. 18B illustrates a sectional view of ballistic armor 1800.

FIG. 18C illustrates a partial sectional view of ballistic armor 1800.

FIG. 18D illustrates an elevation view of a ballistic tile 1804 with mold tabs 1852.

FIG. 18E illustrates a sectional view of ballistic tile 1804 with mold tabs 1852.

FIG. 18F illustrates a partial sectional view of ballistic tile 1804 with mold tabs 1852.

FIG. 18G illustrates a front perspective cutaway view of ballistic armor 1800.

FIG. 18H illustrates a rear elevation view of ballistic armor 1800 including vent ribs 1858.

FIG. 18I illustrates a sectional view of ballistic armor 1800 including vent ribs 1858.

FIG. 19A illustrates a perspective view of an inner housing 1960.

FIG. 19B illustrates a sectional view of inner housing 1960.

FIG. 19C illustrates a perspective exploded view of inner housing 1960 including ballistic tiles 1904.

FIG. 19D illustrates a sectional view of inner housing 1960 including ballistic tiles 1904 and two inserts 1920.

FIG. 19E illustrates a sectional perspective view of inner housing 1960 including ballistic tiles 1904 and two inserts 1920.

FIG. 19F illustrates a perspective exploded view of inner housing 1960 and a first tool half 1980A.

FIG. 19G illustrates a perspective view of inner housing 1960 in first tool half 1980A.

FIG. 19H illustrates a perspective view of first tool half 1980A mated with a second tool half 1980B.

FIG. 19I illustrates a phantom perspective view of a ballistic armor 1900.

FIG. 19J illustrates a sectional view of ballistic armor 1900.

FIG. 19K illustrates a front elevation view of ballistic armor 1900.

FIG. 19L illustrates a rear perspective view of ballistic armor 1900.

### DETAILED DESCRIPTION

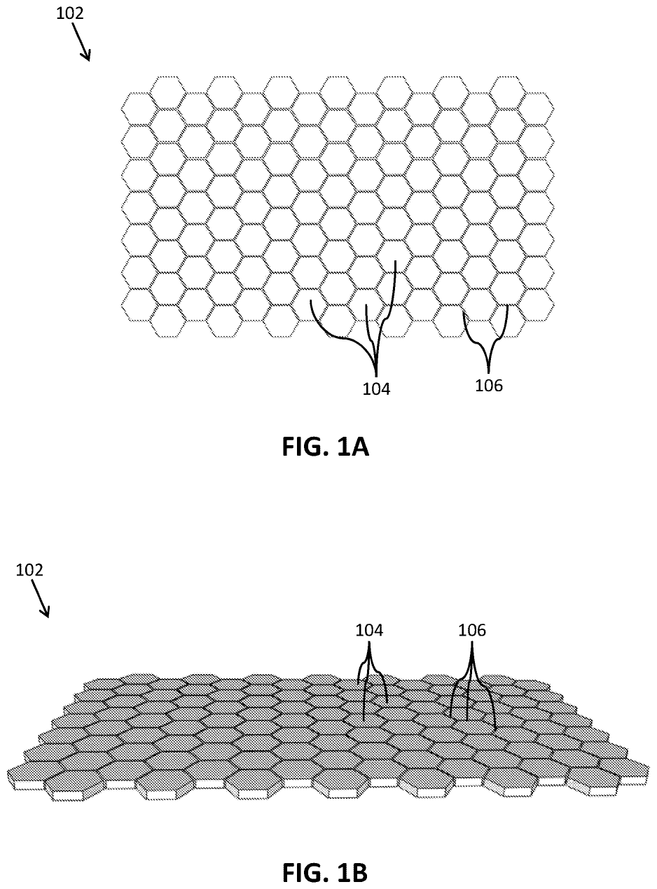

FIGS. 1A-1B illustrates an array 102 of ballistic tiles 104. Ballistic tiles 104 are formed in an array such that ballistic tiles 104 may be spaced from one another with a gap 106 having a dimension (spacing) of e.g., 1/32 in., 1/16 in., ⅛ in., or the like.

Ballistic tiles 104 include a shape able to fit tightly in array 102 as described. All ballistic tiles 104 in array 102 may include the same shape. Ballistic tiles 104 in array 102 may include different shapes selected to fit together. Ballistic tiles 104 may include triangles, squares, rectangles, pentagons, hexagons, octagons, or the like.

Ballistic tiles 104 may include any of a variety of materials, including for example, a ceramic, a composite, a metal (e.g., abrasion resistant steel), a stone, a diamond, a carbon/carbon composite, an alloy (e.g., nickel-based alloys), and the like. Ballistic tiles 104 may all be formed from the same material. Alternatively, ballistic tiles 104 may be formed from varying materials.

Ballistic tiles 104 may include any of a variety of thicknesses. Ballistic tiles 104 may have a thickness necessary for stopping the desired projectile (e.g., a bullet) for a given ballistic tile 104 material. For example, ballistic tiles 104 may have a thickness of ⅛ in., 3/16 in., ¼ in., 5/16 in., ⅜ in., 7/16 in., ½ in., ¾ in., and the like.

Ballistic tiles 104 may have straight sides such that adjacent ballistic tiles 104 have parallel sides, and gap 106 is bounded by parallel sides. Ballistic tiles 104 may have angled sides, such that gap 106 is bounded by angled sides (e.g., forming a “V” shape).

Unless stated otherwise, all arrays described herein may have the properties described with respect to array 102.

Unless stated otherwise, all ballistic tiles described herein may have the properties described with respect to ballistic tiles 104.

Unless stated otherwise, all gaps described herein may have the properties described with respect to gaps 106.

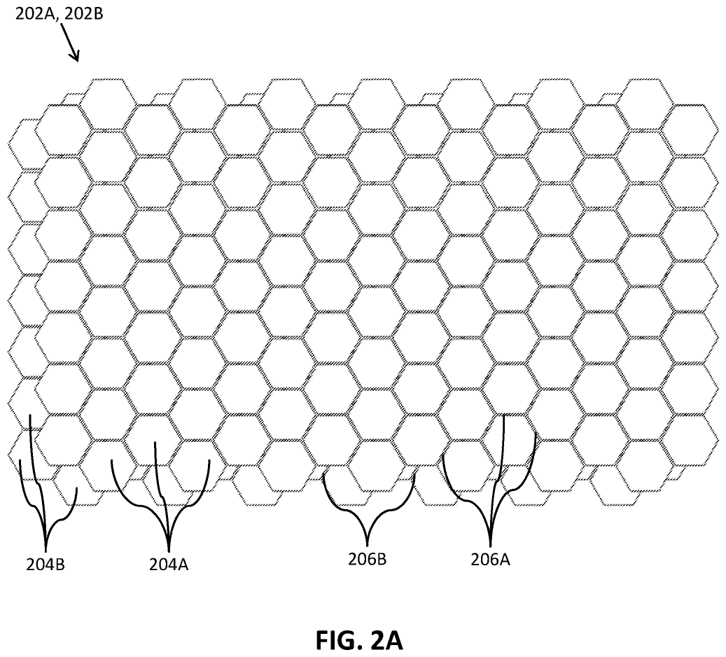

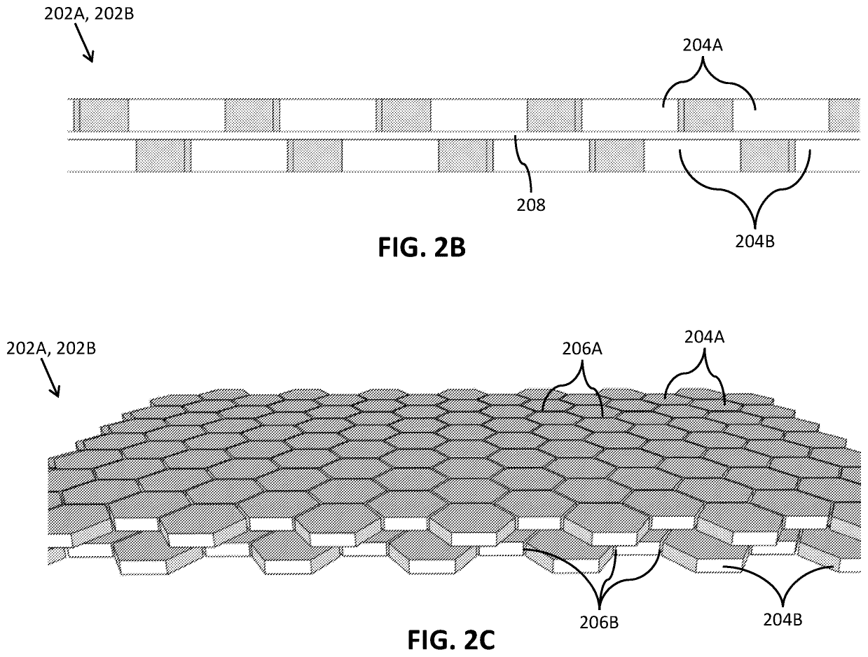

FIGS. 2A-2C illustrate a plurality of stacked arrays 202A, 202B of ballistic tiles 204A, 204B. Arrays 202A, 202B may be stacked upon one another and shifted out of phase with one another, such that gaps 206A and 206B do not align with one another.

Stacked arrays 202A, 202B may be separated by a central space 208. Central space 208 may be any of a variety of thicknesses, including for example 1/32 in., 1/16 in., ⅛ in., or the like.

Additional stacked arrays (not illustrated) may be included as necessary to achieve the desired ballistic armor capabilities. E.g., a third, fourth, or fifth array could be stacked, with varying shifts of phase to avoid alignment of the gaps 206.

Unless stated otherwise, all central spaces described herein may have the properties described with respect to central space 208.

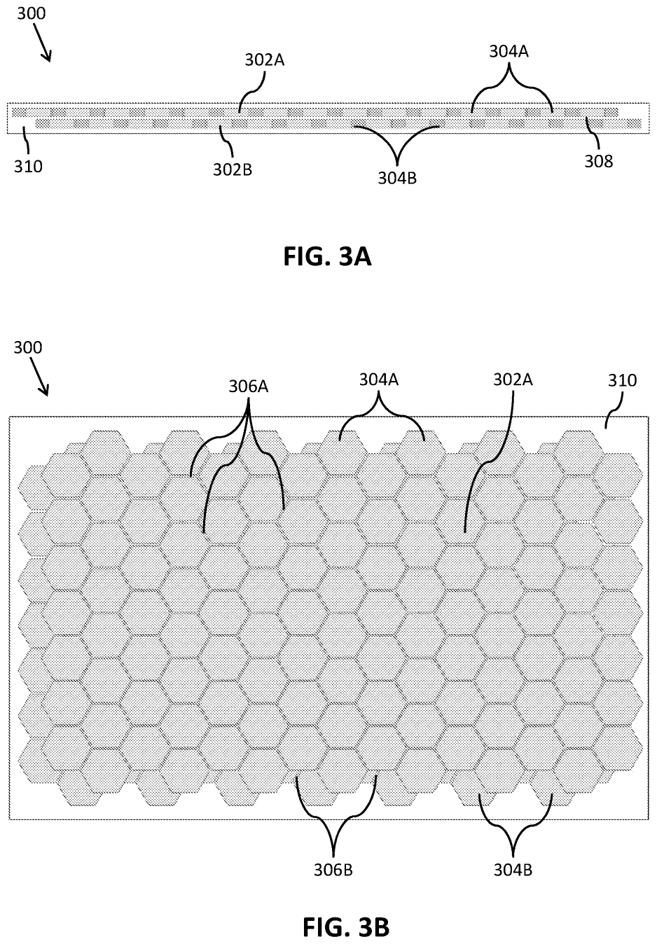

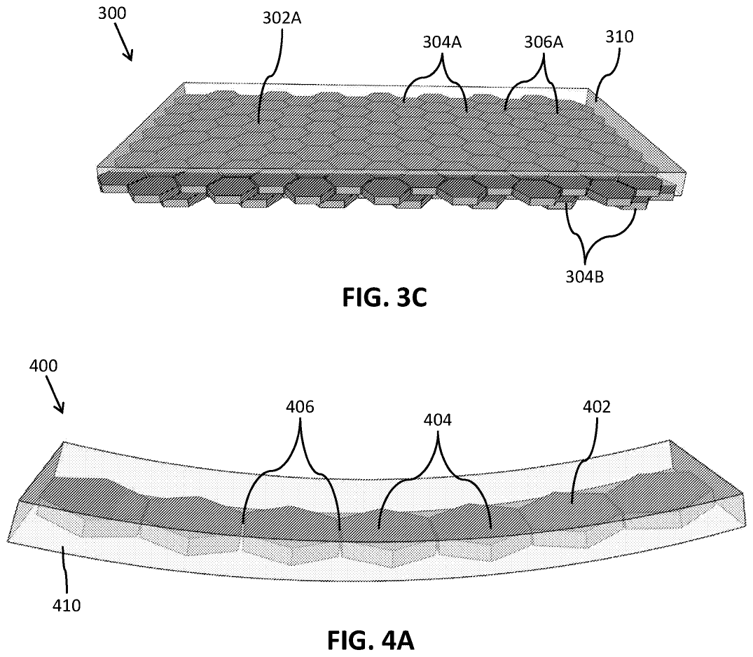

FIGS. 3A-3C illustrate a ballistic armor 300 formed from a plurality of stacked arrays 302A, 302B of ballistic tiles 304A, 304B encapsulated in a polymer 310. Arrays 302A, 302B may be stacked upon one another and shifted out of phase with one another, such that gaps 306A, 306B do not align with one another. Additional arrays 306 may be included as necessary. Central space 308 may be the same as space 208.

Polymer 310 may totally, or partially, encapsulate arrays 302A, 302B. Polymer 310 may occupy gaps 306A, 306B, central space 308, or both. Polymer 310 may extend from above array 302A, through gaps 306A, through central space 308, through gaps 306B, and below array 302B, such that polymer 310 forms a solid encapsulation of all of these elements.

Although not illustrated, additional components may be included within ballistic armor 300, including for example a sheet or plurality of sheets of textile (e.g., a heat-resistant para-aramid synthetic fiber (Kevlar), carbon fiber, fiberglass, polyethylene (including ultra-high molecular weight polyethylene) or the like), a sheet of a metal (e.g., a steel, alloy, or the like), or a sheet of a ceramic material.

Polymer 310 may be any of a variety of polymers, including for example a resin. The resin may be a two-part resin mixed and added to the other components of ballistic armor 300. Polymer 310 may be injected into a tool (e.g., a form/mold) containing the other components of ballistic armor 300. Polymer 310 may be dicyclopentadiene (“DCPD”) resin.

Unless stated otherwise, all polymers described herein may have the properties described with respect to polymer 310.

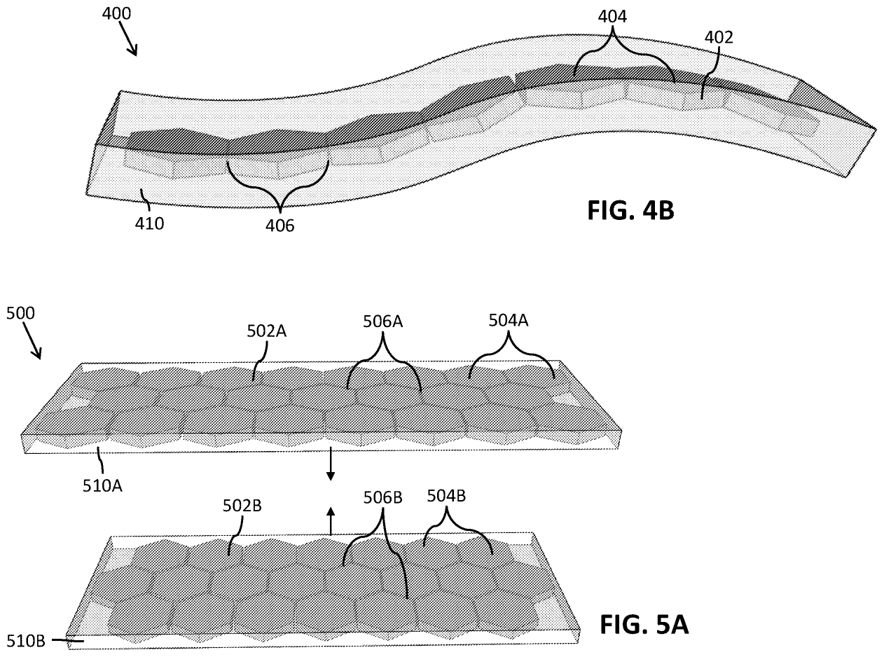

FIGS. 4A-4B illustrate a ballistic armor 400 formed from an array 402 of ballistic tiles 404, with gaps 406, encapsulated in a polymer 410. Ballistic armor 400 and array 402 may include a contour, such as the curved shapes illustrated in FIGS. 4A-4B. These illustrated curved shapes are simple examples and it is contemplated that ballistic armor 400 and array 402 may take any of a variety of complex shapes with the appropriate size (including ballistic tiles 404 of varying size), shape (including ballistic tiles 404 of varying shape), and orientation of ballistic tiles 404. While a single array 402 is illustrated, ballistic armor 400 may include a plurality of arrays as discussed with respect to ballistic armor 300.

Ballistic tiles 404 may include angled edges that when placed adjacent to one another on an angle to form the curved array 402, gaps 406 remain bound by parallel sides. E.g., ballistic tiles 404 may have a cross-sectional shape of a trapezoid, or the shape of a trapezoid prism.

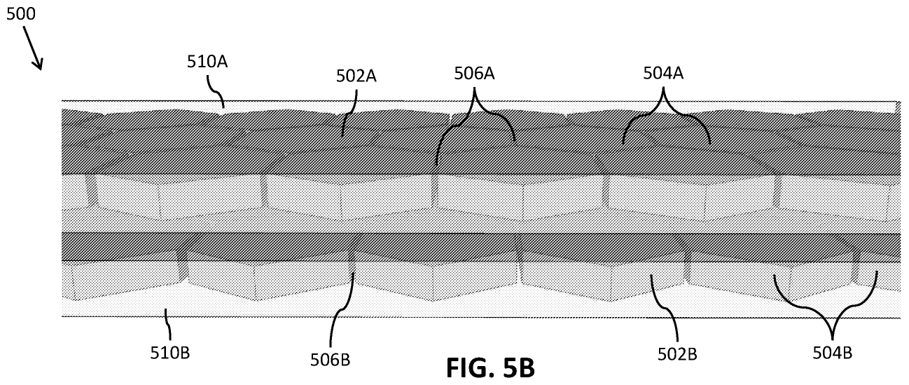

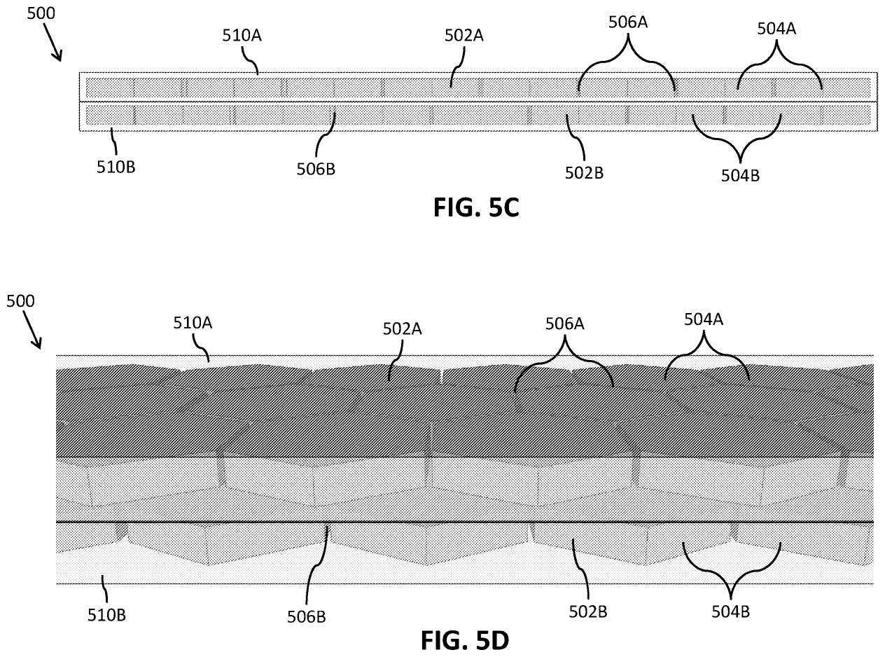

FIGS. 5A-5D illustrate an alternative method of manufacturing ballistic armor 500, wherein a plurality of arrays 502A, 502B of ballistic tiles 504A, 504B, with gaps 506A, 506B are encapsulated within polymers 510A, 510B, respectively, and thereafter layered upon one another (see FIGS. 5C and 5D) and bonded to one another via an adhesive, application of additional resin, or the like. Alternatively, or additionally, the bonding may be effected via fasteners.

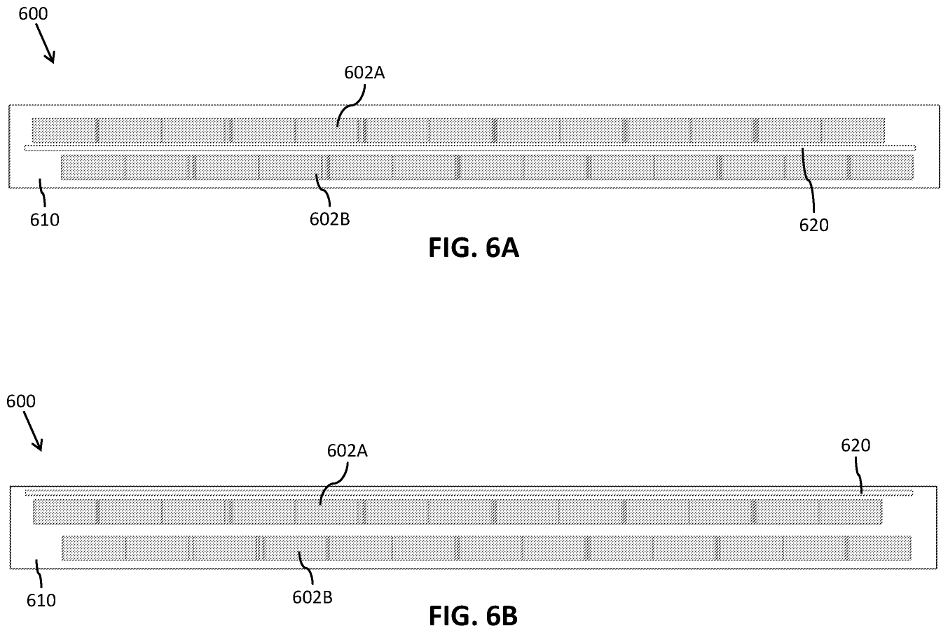

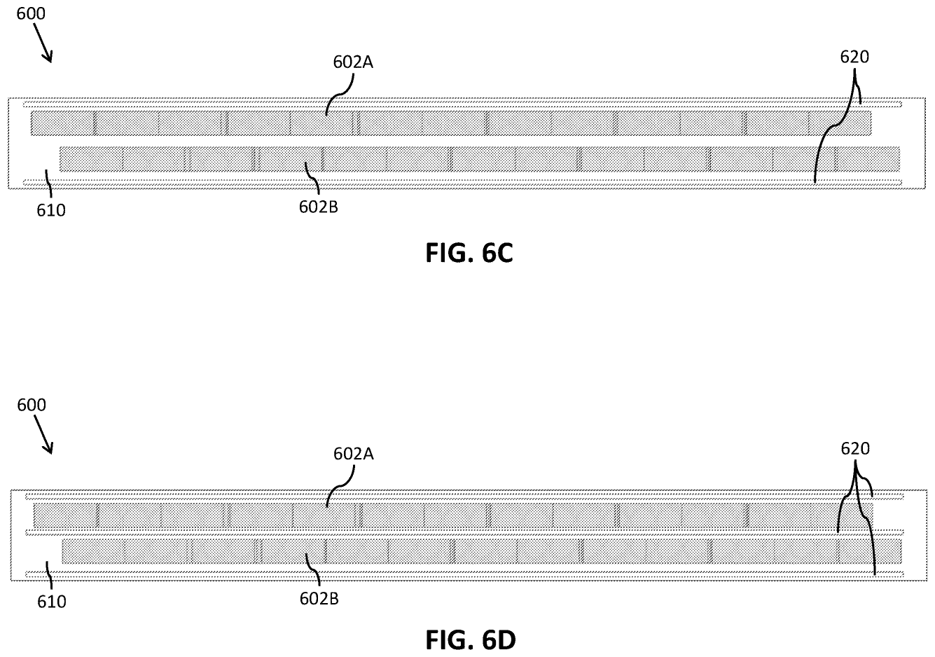

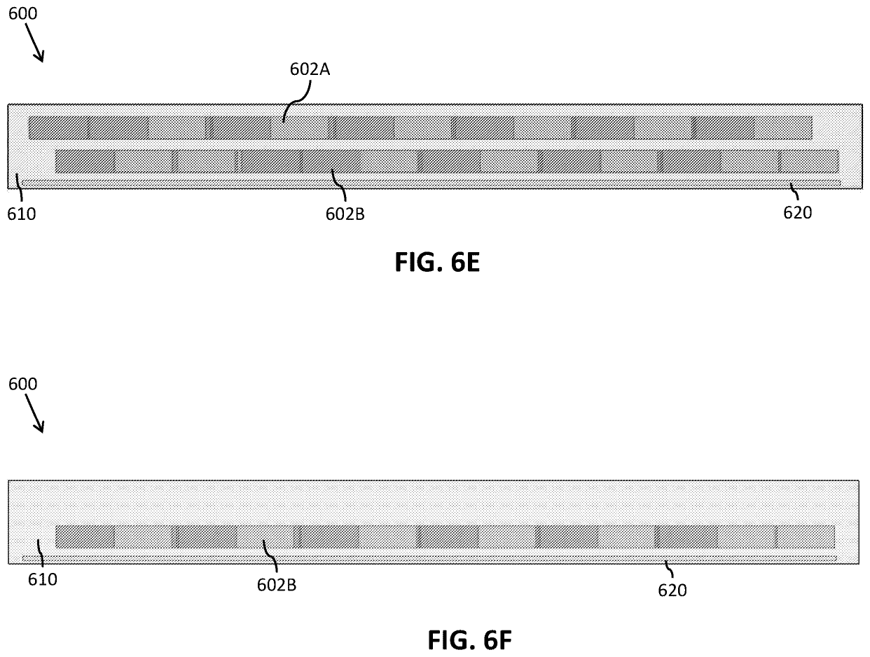

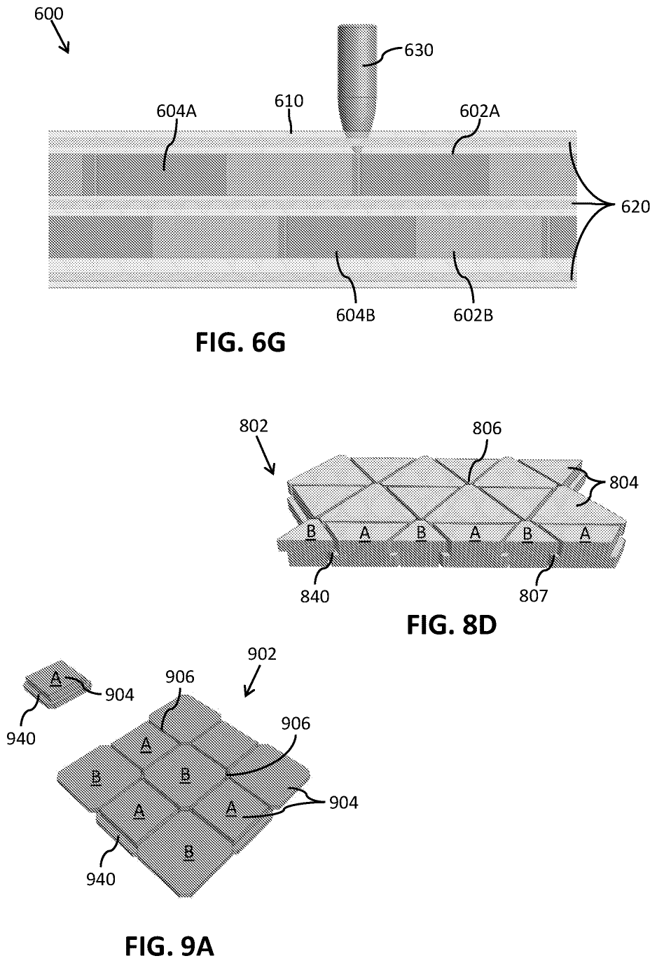

FIGS. 6A-6G illustrates an elevation view of ballistic armor 600 formed from stacked arrays 602A, 602B or single array 602B encapsulated in a polymer 610, including various arrangements of inserts 620.

Inserts 620 may include, for example a sheet or plurality of sheets of textile (e.g., a heat-resistant para-aramid synthetic fiber (Kevlar), carbon fiber, fiberglass, polyethylene (including ultra-high molecular weight polyethylene) or the like), a sheet of a metal (e.g., a steel, alloy, or the like), a metallic screen, a metallic foil, or a sheet of a ceramic material. Insert 620 may be used for reinforcing/strengthening ballistic armor 600. Insert 620 may be used to block electromagnetic waves/radiation, radio frequency waves/radiation, and the like, from passing through ballistic armor 600. Insert 620 may be used for both reinforcing/strengthening ballistic armor 600 as well as blocking waves/radiation from passing through ballistic armor 600.

Insert 620 may help contain spalling of ballistic tiles 604A, 604B upon impact by a projectile, such as projectile 630. Projectile 630 may be any projectile, such as a bullet, fragmentation, shrapnel, and the like. Insert 620 may be bonded to ballistic tiles 604A, 604B to assist in maintaining the position of ballistic tiles 604A, 604B both before and after encountering projectile 630. Insert 620 may provide additional tensile strength to ballistic armor 600. Projectile 630 may be a bullet with a diameter of about 0.20 in. or greater.

When projectile 630 impacts the strike face of ballistic armor 600, it first encounters polymer 610, then either an insert 620 or ballistic tiles 604A, 604B (depending upon the embodiment). The energy of the impact of projectile 630 may cause ballistic tiles 604A, 604B to fracture, and particles of ballistic tiles 604A, 604B to be ejected laterally and back toward the direction from which projectile 630 came. That is, the energy vectors of fragments/spalling of ballistic tiles 604A, 604B and/or projectile 630 (upon its breaking up) are generally angled in a cone that extends both laterally (away from projectile 630) and back toward the direction from which projectile 630 traveled. Both polymer 610 and insert 620 may act to capture fragments/spalling after impact. Both polymer 610 and insert 620 may act to retain the position of ballistic tiles 604A, 604B after impact. Both polymer 610 and insert 620 may act to capture and absorb projectile 630 within ballistic armor 600 after impact rather than allow projectile 630 to deflect/ricochet.

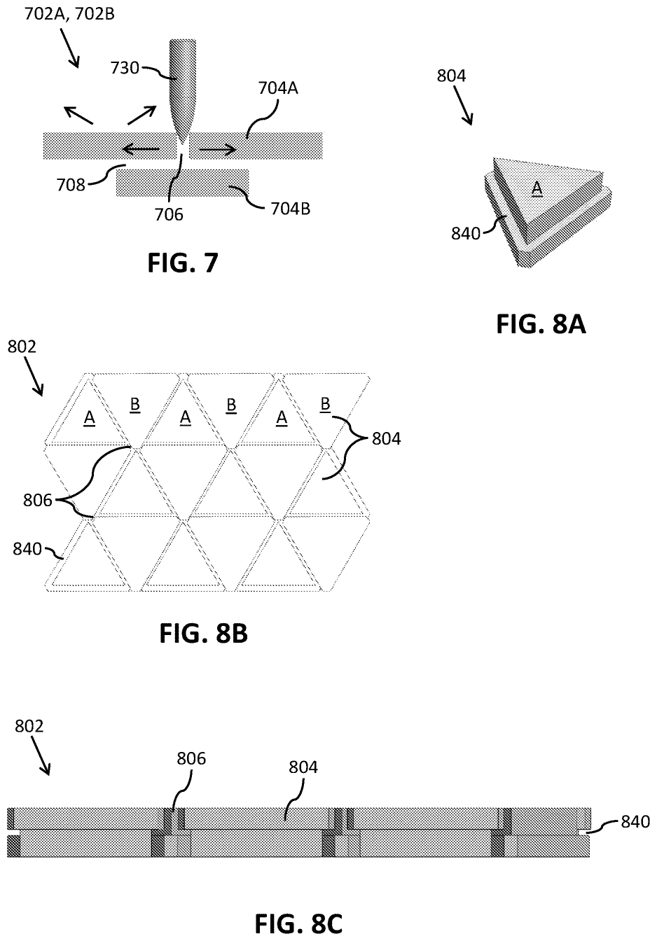

FIG. 7 illustrates an elevation view of stacked arrays 702A, 702B encountering a projectile 730. The most difficult point to stop projectiles 730 is at gaps 706 between adjacent ballistic tiles 704A or 704B within arrays 702A, 702B. When using an array of ballistic tiles 704A or 704B, gaps 706 are inherently present, and projectile 730 may enter gap 706 relatively uninhibited until parts of projectile 730 encounter array 702A formed from ballistic tiles 704A. To combat this, it is important to ensure that gap 706 is as small as possible, and that the proper overlap exists between ballistic tiles in gap 706 to ensure that projectile 730 cannot penetrate the ballistic armor.

Additionally, FIG. 7 includes arrows showing the forces imparted to ballistic tiles 704A or 704B upon impact from projectile 730. Accordingly, ballistic tiles 704A or 704B need to be constrained both laterally and toward the strike face (i.e., in the direction from which projectile 730 came. A polymer and/or an insert may be used to constrain ballistic tiles 704A or 704B.

FIGS. 8A-8D illustrate triangular ballistic tiles 804 having a stepped edge 840, often arranged in an array 802. Triangular ballistic tiles 804 include stepped edges 840 around their perimeter. Triangular ballistic tiles 804 include truncated points on stepped edges 840. FIG. 8A illustrates triangular ballistic tile 804 with its “A-side” oriented upwardly.

FIGS. 8B-8D illustrate an array 802 of triangular ballistic tiles 804 having stepped edge 840. Contiguous triangular ballistic tiles 804 include gaps 806. As illustrated, array 802 is formed by alternating contiguous tiles with “A-side” oriented upwardly and “B-side” oriented upwardly. In this manner, stepped edges 840 of ballistic tiles 804 interlock with one another to eliminate a clear path through which a projectile 830 may extend from a strike face to a back face of a ballistic armor formed from triangular ballistic tiles 804. FIG. 8D illustrates a sectional view of array 802 of triangular ballistic tiles 804 illustrating the interlock of stepped edges 840 formed from alternating contiguous tiles with “A-side” oriented upwardly and “B-side” oriented upwardly.

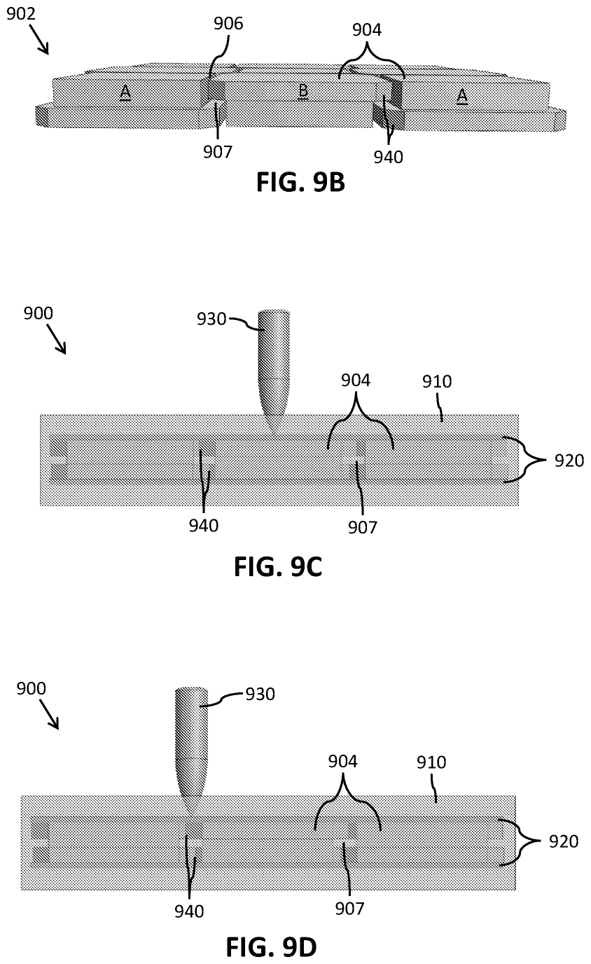

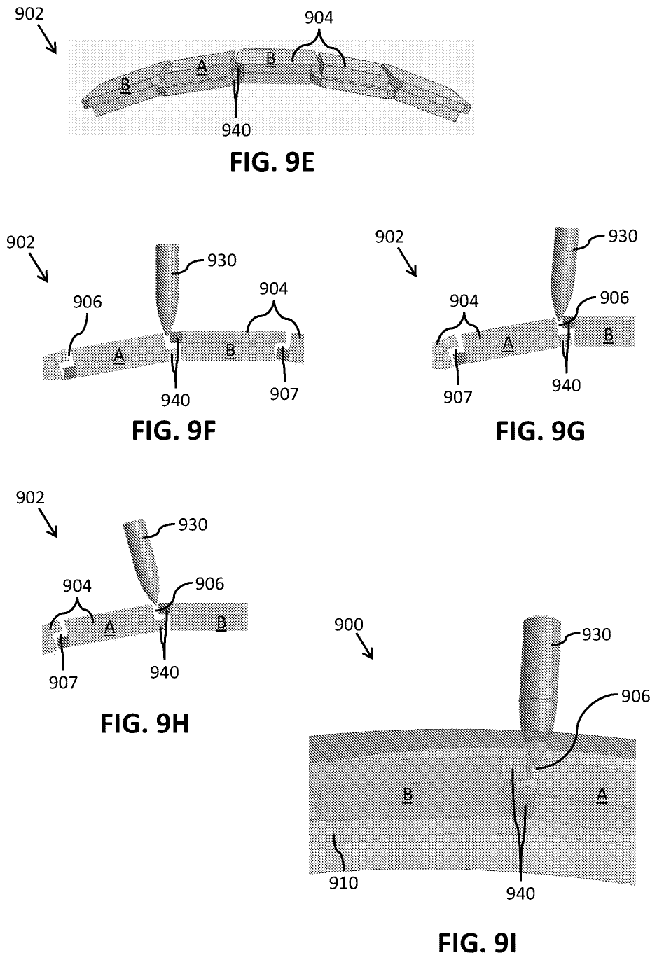

FIG. 9A-9I illustrates a perspective view of an array 902 of square ballistic tiles 904 having a stepped edge 940. Contiguous square ballistic tiles 904 include gaps 906.

As illustrated in FIG. 9E, arrays 902 may take a curved shape while still ensuring that stepped edges 940 overlap and interlock.

As illustrated in FIGS. 9F-9H, arrays 902 may encounter a projectile 930 at gap 906. The overlap and interlocking of stepped edges 940 prevent a direct path for projectile 930 to pass between contiguous ballistic tiles 904.

As illustrated in FIG. 9I, ballistic armor 900 is formed from encapsulating array 902 in a polymer 910, with the polymer 910 extending completely through gap 906 from one side of array 902 to the other.

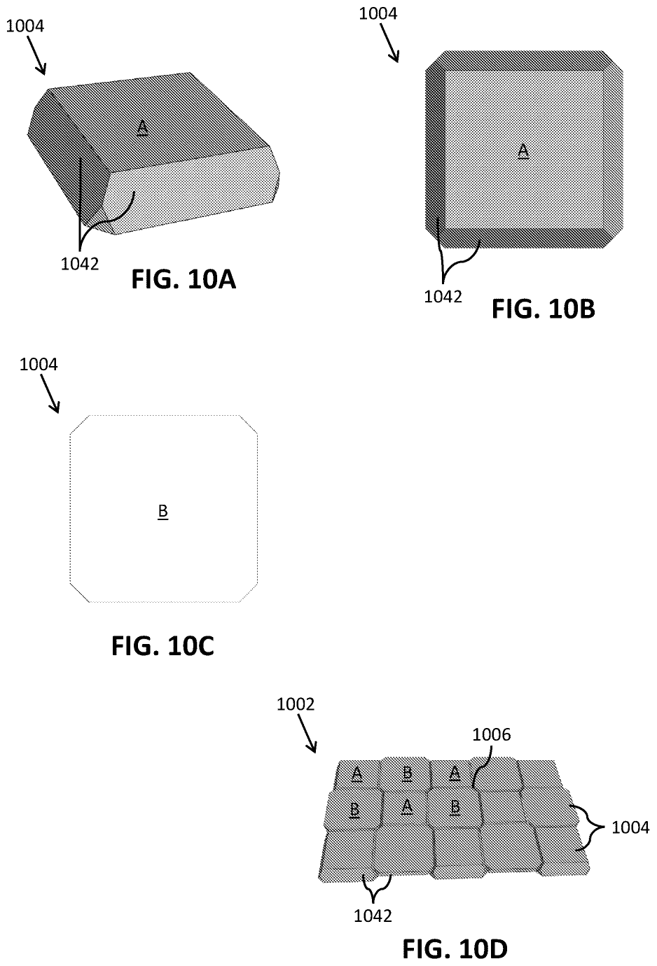

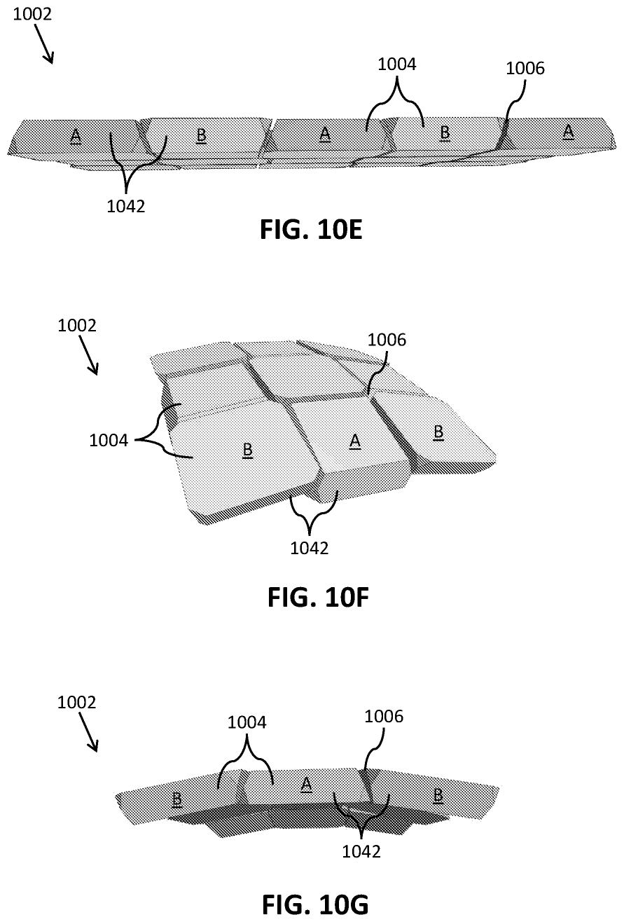

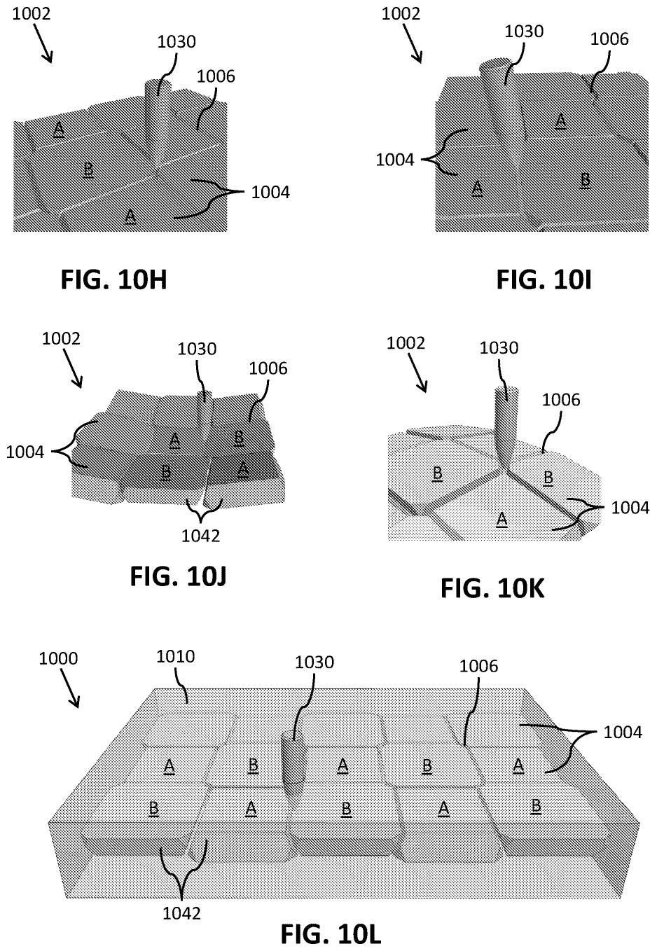

FIGS. 10A-10C illustrates square ballistic tiles 1004 having an angled edge 1042. As illustrated, ballistic tiles 1004 have an “A-side” and a “B-side.” The “A-side” is that side that has a smaller area than the “B-side.” Square ballistic tiles 804 include truncated points.

FIGS. 10D-10K illustrate an array 1002 of square ballistic tiles 1004 having angled edges 1042. Contiguous square ballistic tiles 1004 include gaps 1006. As illustrated, array 1002 is formed by alternating contiguous tiles with “A-side” oriented upwardly and “B-side” oriented upwardly. In this manner, angled edges 1042 of ballistic tiles 1004 interlock with one another to eliminate an orthogonal path through which a projectile 1030 may extend from a strike face to a back face of a ballistic armor formed from square ballistic tiles 1004.

As illustrated in FIGS. 10F-10K, array 1002 can be curved in shape. Either the concave or convex surface may be a strike face. Gaps 1006 continue to be minimal when array 1002 is curved.

As illustrated in FIG. 10L, ballistic armor 1000 is formed from encapsulating array 1002 in a polymer 1010, with the polymer 1010 extending completely through gap 1006 from one side of array 1002 to the other.

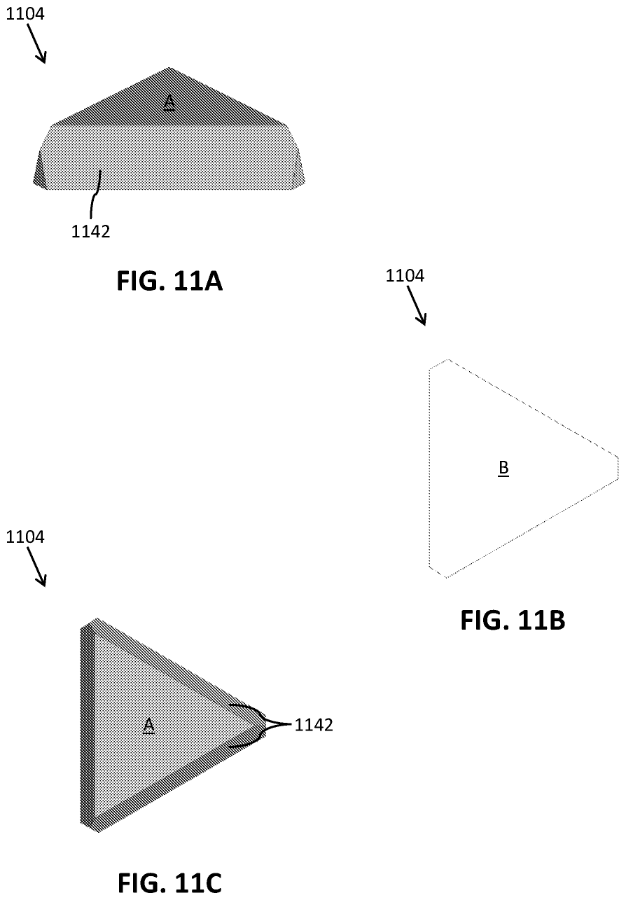

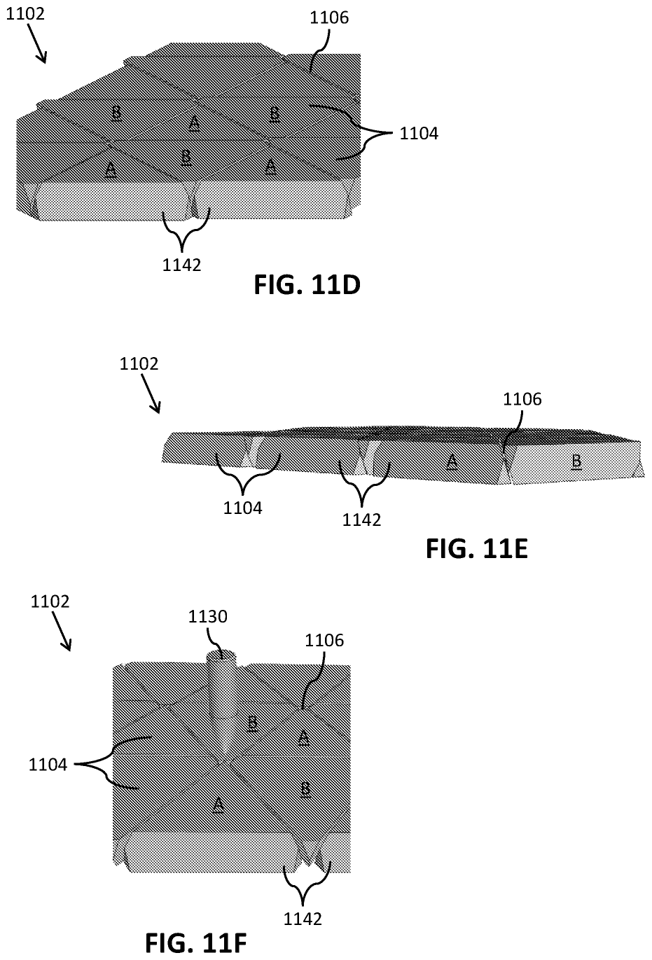

FIGS. 11A-11C illustrates a triangular ballistic tile 1104 having an angled edge 1142. As illustrated, ballistic tiles 1104 have an “A-side” and a “B-side.” The “A-side” is that side that has a smaller area than the “B-side.” Triangular ballistic tiles 1104 include truncated points.

FIGS. 11D-11F illustrate an array 1102 of triangular ballistic tiles 1104 having angled edges 1142. Contiguous triangular ballistic tiles 1104 include gaps 1106. As illustrated, array 1102 is formed by alternating contiguous tiles with “A-side” oriented upwardly and “B-side” oriented upwardly. In this manner, angled edges 1142 of ballistic tiles 1104 interlock with one another to eliminate an orthogonal path through which a projectile 1130 may extend from a strike face to a back face of a ballistic armor formed from triangular ballistic tiles 1104.

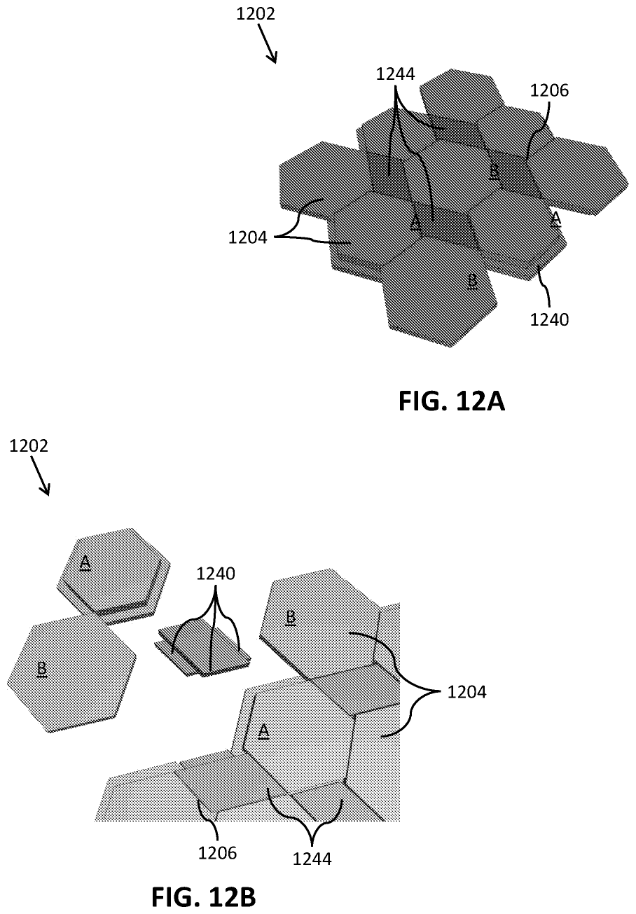

FIGS. 12A-12B illustrate a perspective view of an array 1202 of hexagonal ballistic tiles 1204 and parallelogram ballistic tiles 1244, having stepped edges 1240. Contiguous ballistic tiles 1204 and 1244 include gaps 1206. As illustrated, array 1202 is formed by alternating contiguous tiles 1204 with “A-side” oriented upwardly and “B-side” oriented upwardly, with ballistic tiles 1244 filling in blank areas in array 1202. In this manner, stepped edges 1240 of ballistic tiles 1204 and 1244 interlock with one another to eliminate a clear path through which a projectile may extend from a strike face to a back face of a ballistic armor formed from ballistic tiles 1204, 1244.

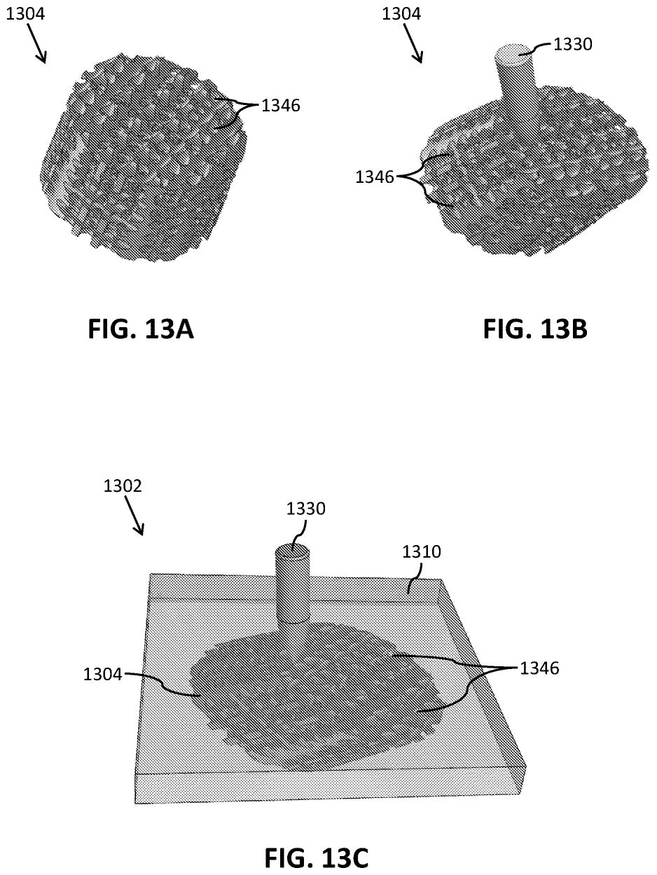

FIG. 13A-13C illustrates a ballistic foam 1304 having a plurality of pores 1346. Ballistic foam 1304 may be a ceramic foam, metallic foam, or the like. That is, ballistic foam 1304 may be, for example, a very porous ceramic foam 1304. As illustrated in FIG. 13C, ballistic foam 1304 may be encapsulated in a polymer 1310, such that polymer 1310 extends completely through pores 1346 from one side of ballistic foam 1304 to another, to form a solid without any voids or air gaps.

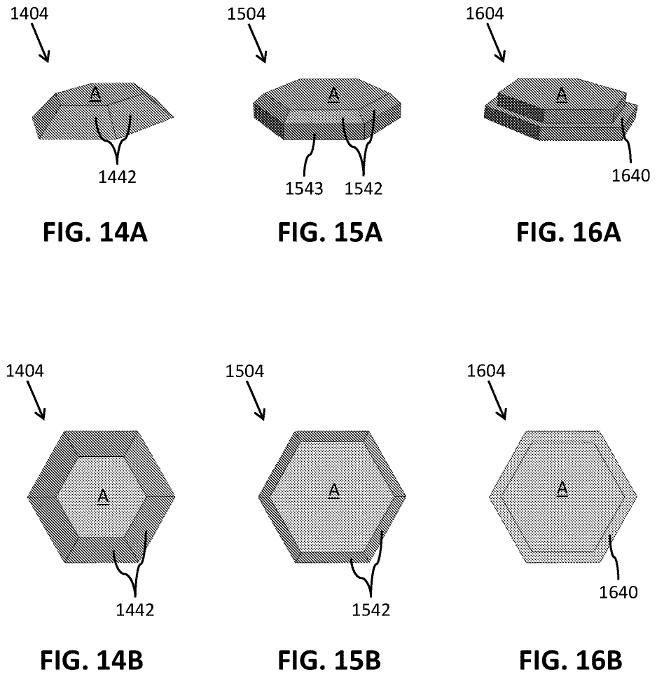

FIGS. 14A-14B illustrates a hexagonal ballistic tile 1404 having an angled side 1442.

FIGS. 15A-15B illustrates a hexagonal ballistic tile 1504 having an angled edge 1542 and a straight side 1543.

FIGS. 16A-16B illustrates a hexagonal ballistic tile 1604 having a stepped edge 1640.

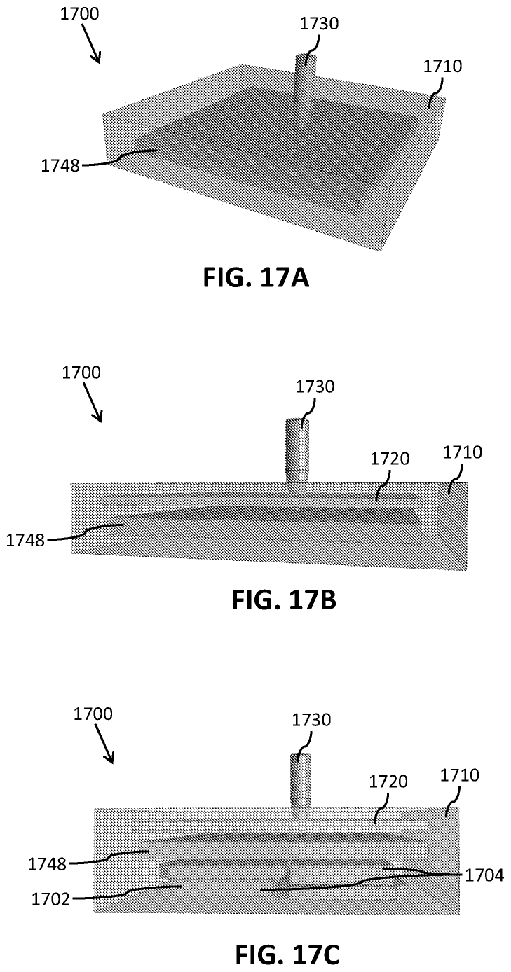

FIG. 17A illustrates a perspective view of ballistic armor 1700 including a perforated plate 1748 encapsulated in a polymer 1710. Perforated plate 1748 may be any of a variety of materials, including for example, steel. Perforated plate 1748 may be abrasion resistant steel. Optionally, armor 1700 and perforated plate 1748 may be curved, and the bending of perforated plate 1748 is easier due to perforations. Additionally, perforated plate 1748 has a reduced weight due to perforations.

FIG. 17B illustrates a perspective view of ballistic armor 1700 including perforated plate 1748 and an insert 1720, all encapsulated in polymer 1710. Armor 1700 may be curved, along with perforated plate 1748 and insert 1720. Insert 1720 may be made from the same materials as inserts 620.

FIG. 17C illustrates a perspective view of ballistic armor 1700 including perforated plate 1748, insert 1720, and an array 1702 of ballistic tiles 1704, all encapsulated in polymer 1710. Armor 1700 may be curved, along with perforated plate 1748, insert 1720, and array 1702. Array 1702 may be formed from any of the ballistic tiles, ballistic sheets, or ballistic foams described herein.

Ballistic armor 1700 may encounter a projectile 1730. The size of perforations in perforated plate 1748 may be selected to ensure that projectile 1730 cannot pass through perforated plate 1748 uninhibited.

Alternatively, perforated plate 1748 may be replaced with a solid plate of steel (e.g., lacking perforations).

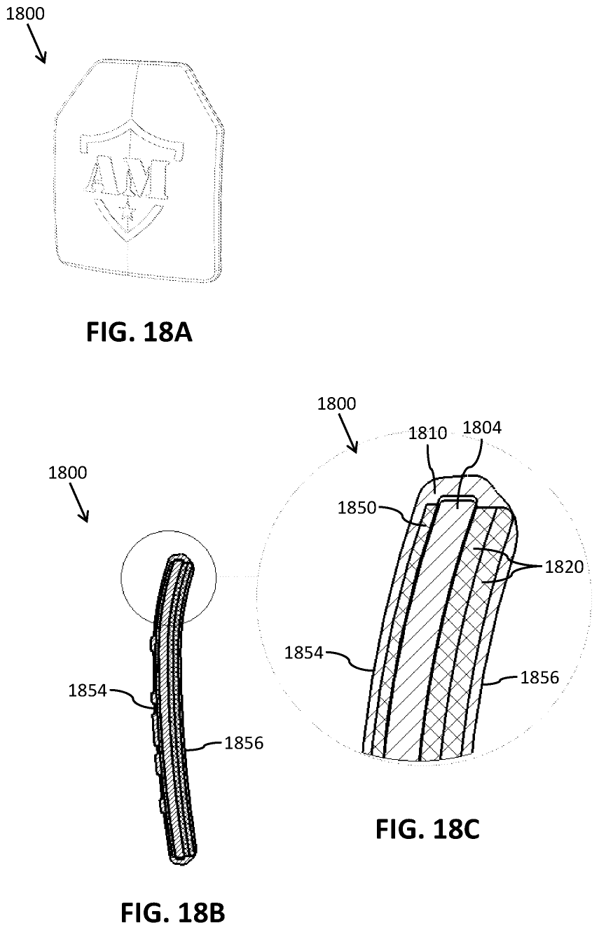

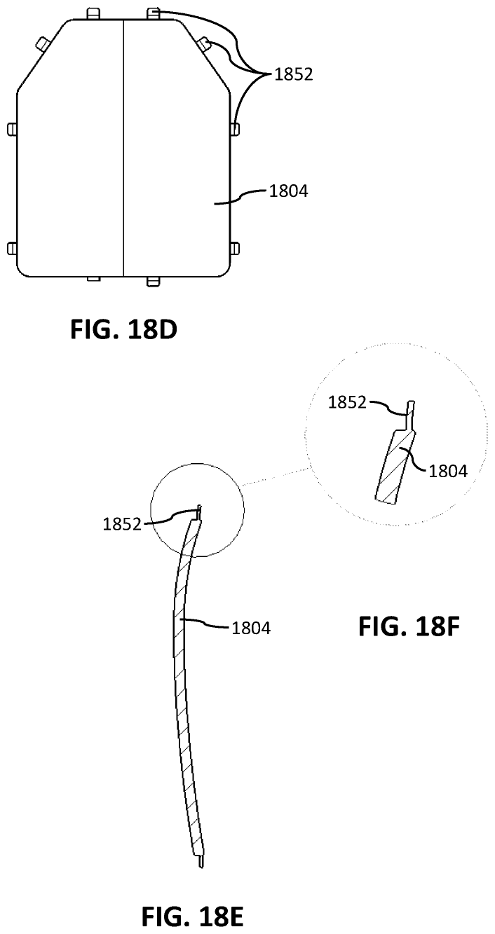

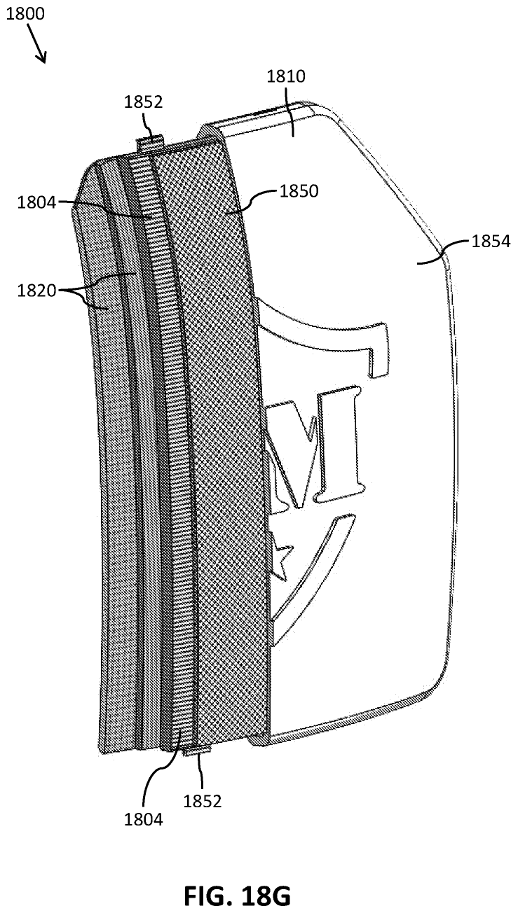

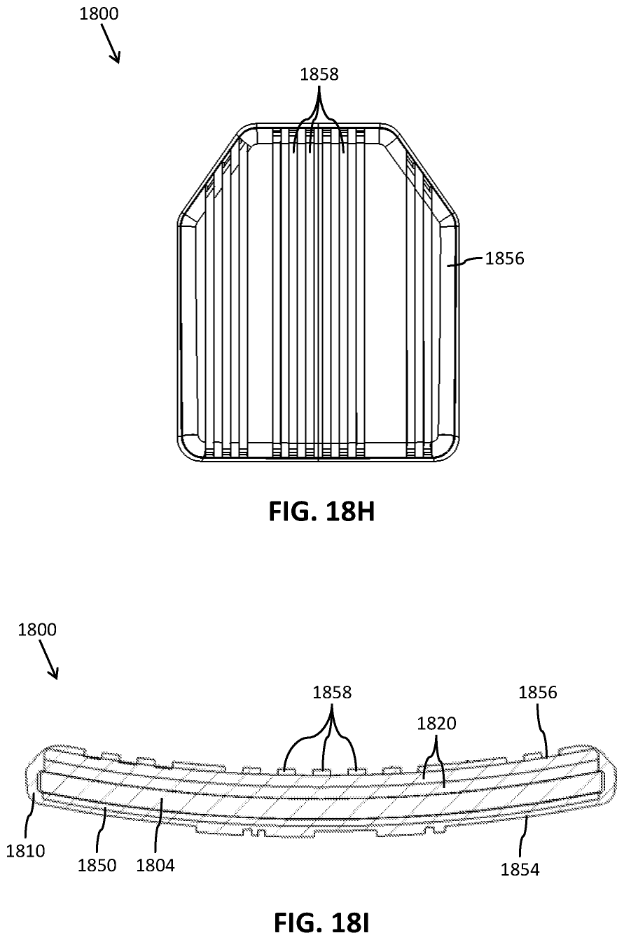

FIGS. 18A-18I illustrates a ballistic armor 1800. Armor 1800 includes a front 1854 and a back 1856. Front 1854 may be a strike face. Back 1856 may be a wear face.

Armor 1800 includes one or more ballistic tile 1804. Armor 1800 may include a single one piece ballistic tile 1804, or an array of ballistic tiles 1804.

Armor 1800 may include one or more layer of insert 1820 between ballistic tile 1804 and back 1856. Armor 1800 may include two layers of insert 1820 laminated together. Insert 1820 may include a sheet or plurality of sheets of a textile (e.g., a heat-resistant para-aramid synthetic fiber (Kevlar), carbon fiber, fiberglass, polyethylene (including ultra-high molecular weight polyethylene) or the like).

Armor 1800 may optionally include a supplemental layer 1850 between ballistic tile 1804 and front 1854. Supplemental layer 1850 may include a closed-cell rubber material to provide padding during of ballistic tile 1804 against impacts such as impact with a hard surface. Supplemental layer 1850 may include a honeycomb material to provide additional strength, rigidity, and/or density between ballistic tile 1804 and front 1854. Supplemental layer 1850 may include a material (e.g., a honeycomb material) to provide additional strength, rigidity, and/or density to help yaw a projectile passing from front 1854 toward ballistic tile 1804. Supplemental layer 1850 may be a honeycomb or similar material with a series of cells, and the cells may be filled with polymer 1810 resulting in supplemental layer 1850 having varied densities that may assist in yawing a projectile.

Armor 1800 may include a polymer 1810 encapsulating all or part of one or more ballistic tile 1804, one or more insert 1820, and optionally supplemental layer 1850. In one aspect, ballistic tile 1804 may be entirely encapsulated in polymer 1810 prior to manufacturing of armor 1800, and polymer 1810 may act to constrain ballistic tile 1804 after ballistic tile 1804 is struck by a projectile and is fractured.

During manufacturing, ballistic tile 1804 (whether a single unit, or an array bonded to a substrate) is suspended within a tool (e.g., a mold), with one or more insert 1820 and optionally supplemental layer 1850. One or more mold tab 1852 (e.g., a series of discontinuous mold tabs 1852, or a single continuous mold tab 1852) is attached at least to ballistic tile 1804. One or more mold tab 1852 engages one or more corresponding surfaces within the tool to suspend ballistic tile 1804 in a desired location in the tool to ensure that the desired thickness of polymer 1810 is achieved at front 1854, back 1856, and the outer sides extending between front 1854 and back 1856. One or more mold tabs 1852 may ultimately extend out of the outer sides from polymer 1810 and be manually trimmed after manufacture of armor 1800, alternatively may be encapsulated within polymer 1810 like the remaining elements of armor 1800, or a combination of both (e.g., some mold tabs are trimmed while others are encapsulated).

Mold tabs 1852 may include clips that clamp onto ballistic tile 1804. Mold tabs 1852 may extend from a frame that is sized and shaped to fit around the edges of ballistic tile 1804. Mold tabs 1852 may extend from a layer of material oriented between ballistic tile 1804 and front 1854, between ballistic tile 1804 and back 1856, or both. Ballistic tile 1804 may be at least partially encapsulated in polymer 1810 prior to manufacture of armor 1800, and mold tabs 1852 may be formed from polymer 1810.

Armor 1800 may include a plurality of vent ribs 1858. Vent ribs 1858 may extend vertically. Vent ribs 1858 may provide channels for heat to escape between the remainder of back 1856 and a wearer's body. Vent ribs 1858 may provide channels for air to flow between the remainder of back 1856 and a wearer's body. Vent ribs 1858 may provide additional stiffness to armor 1800.

Front 1854 may include varied thicknesses, patterns, and/or densities of polymer 1810 to assist in the yawing of a projectile striking armor 1800.

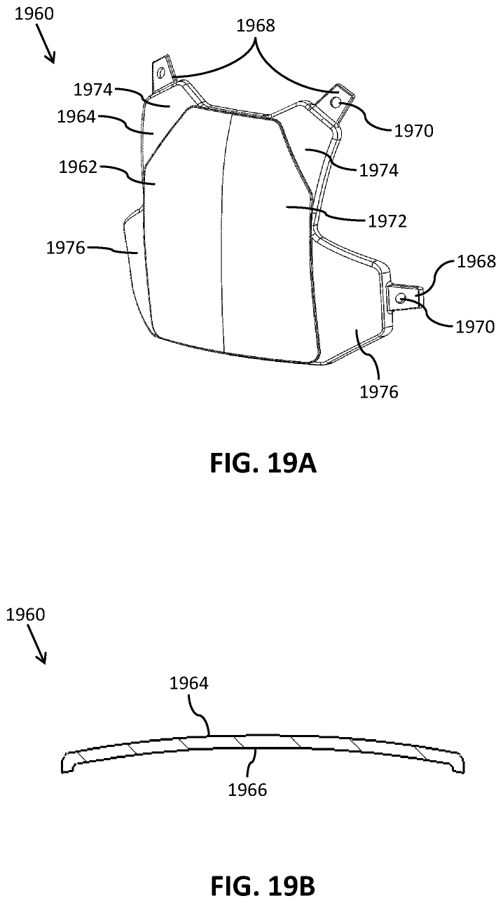

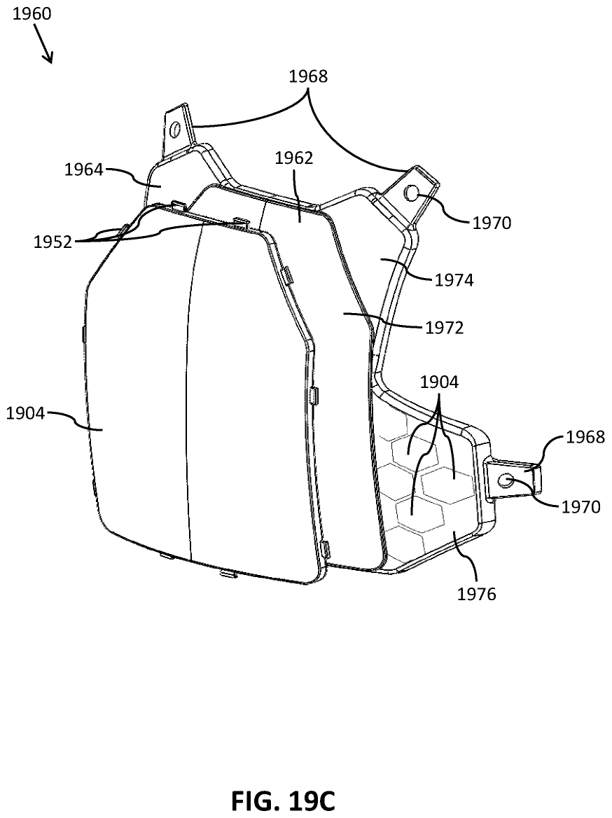

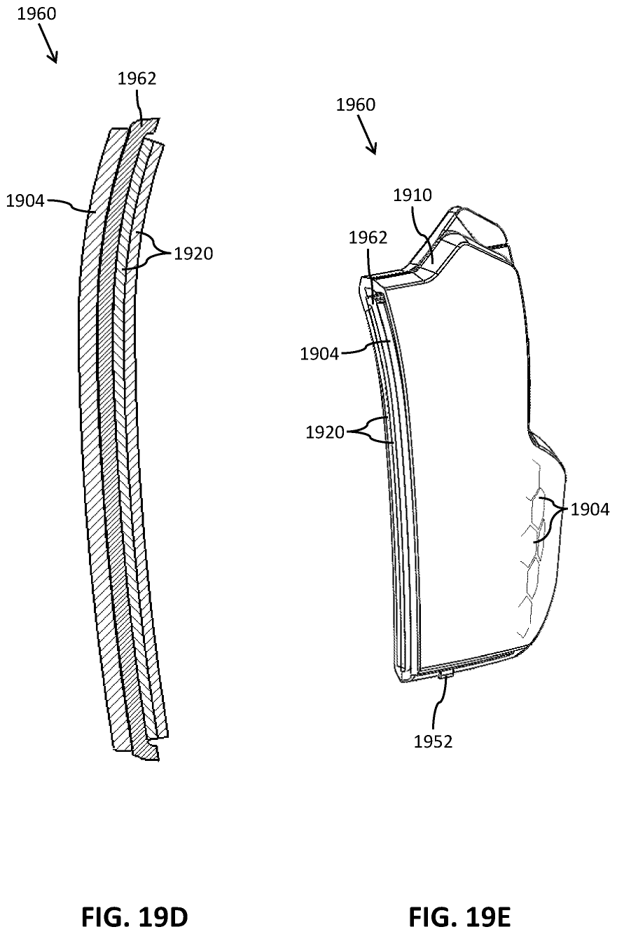

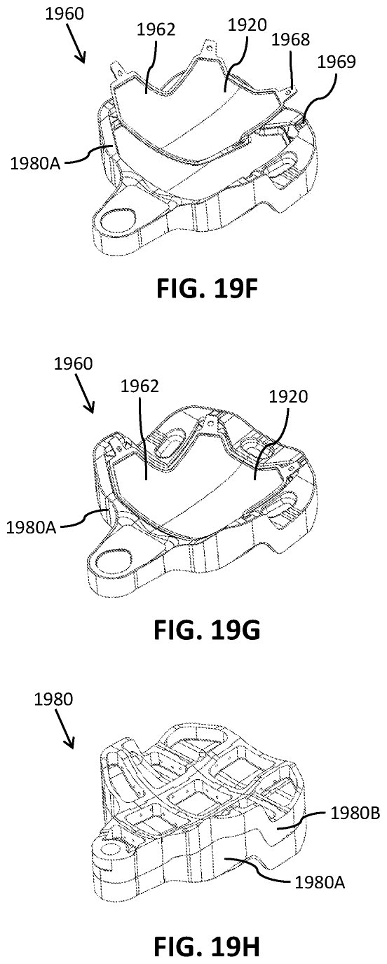

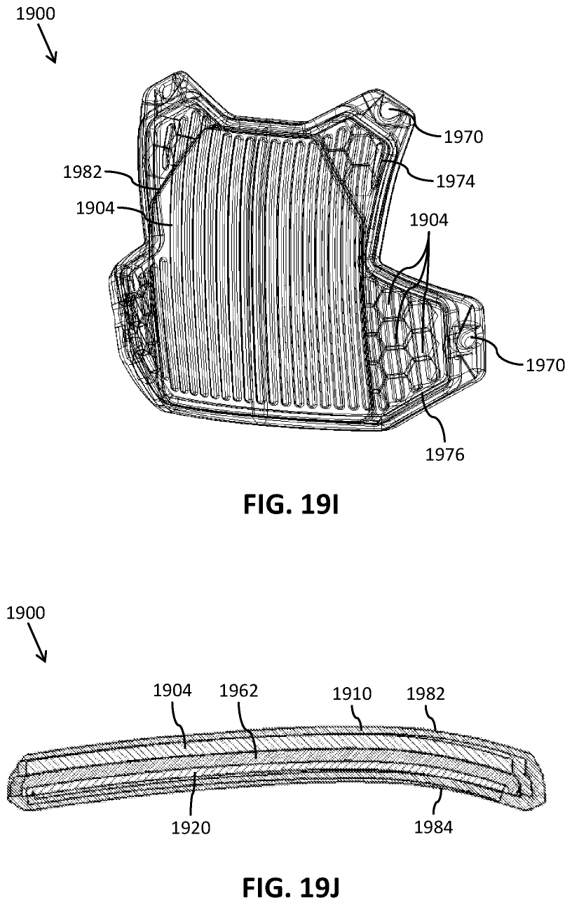

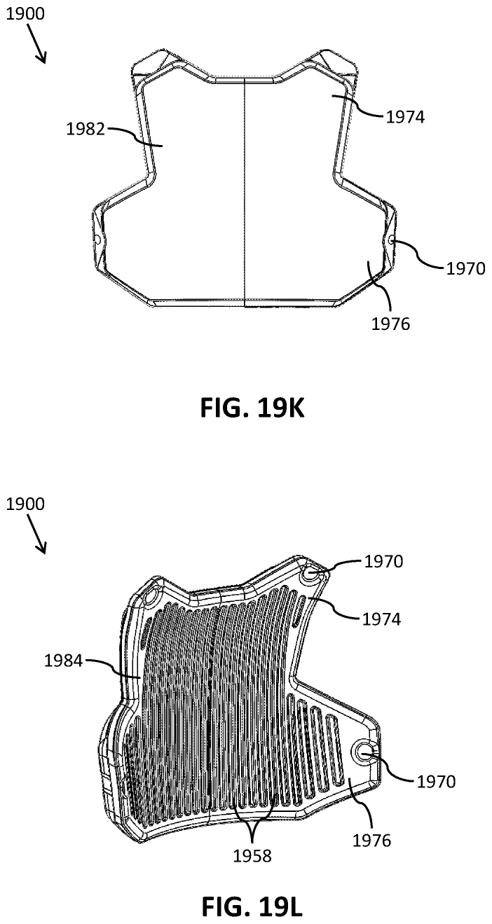

FIGS. 19A-19E illustrate an inner housing 1960. Inner housing may be formed from a polymer, including for example the same polymer as noted above (e.g., polymer 1810).

Inner housing 1960 includes a body portion 1962 having a front 1964 and a back 1966. Front 1964 may include ballistic tile mounting areas 1972, 1974, 1976. Mounting area 1972 may correspond to a wearer's central chest and back region, while mounting areas 1974 correspond to a wearer's shoulder regions and mounting areas 1976 correspond to a wearer's torso side regions.

Inner housing 1960 may include one or more tooling tab 1968. One or more tooling tab 1968 engages one or more corresponding surfaces 1969 within a tool 1980A, 1980B to suspend inner housing 1960 in a desired location in tool 1980A, 1980B to ensure that the desired thickness of polymer 1910 is achieved at an armor front 1982, back 1984, and the outer sides extending between front 1982 and back 1984. One or more tooling tab 1968 may include a fastener aperture 1970 for attaching a strap, bracket, mount, or the like to attach a first ballistic armor 1900 to a second ballistic armor 1900 (e.g., for a wearer's front and back) as described further below. The fastener may include a bolt or screw.

As illustrated in FIG. 19C, a large tombstone-shaped ballistic tile 1904 may be mounted to mounting area 1972. This ballistic tile 1904 may or may not include mold tabs 1952. Small hexagonal ballistic tiles 1904 may be mounted to mounting areas 1974 and 1976. Alternatively, small hexagonal tiles 1904 may be mounted to mounting area 1972 instead of or in addition to large tombstone-shaped ballistic tile 1904. Alternatively, large appropriately-shaped ballistic tiles 1904 may be mounted to mounting areas 1974 and 1976. The objective is to cover mounting areas 1972, 1974, 1976 with ballistic tiles 1904, and it is understood that any combination of sizes, shapes, and curvature of ballistic tiles and ballistic tile arrays may be used to effect this objective. Additionally, ballistic tiles 1904 in more critical areas, such as those in mounting area 1972, may be designed to be thicker and/or more projectile resistant (e.g., NIJ Level IV) than ballistic tiles 1904 in less critical areas, such as those in mounting area 1974, which may be designed to be thinner, lighter, and thus less projectile resistant (e.g., NIJ Level III). This variation in projectile resistance may be selected by one ordering ballistic armor 1900 to optimize weight and thicknesses of ballistic armor 1900 in various areas as balanced against projectile resistance. Ballistic tiles 1904 may be mounted to mounting areas 1972, 1974, 1976 via any of a variety of bonding mechanisms, including for example, an adhesive agent or a double-sided tape.

As illustrated in FIG. 19D, one or more insert 1920 may be mounted to back 1966 of body 1962, opposite ballistic tiles 1904. Alternatively, thinner insert 1920 or no insert 1920 may be included in those areas deemed by the end user to be less critical, as noted above, to permit the thinning and lightening of that portion of armor 1900. FIG. 19D illustrates one potential aspect of an assembled inner housing 1960, which is ready for further processing to form ballistic armor 1900.

FIGS. 19F-19H illustrate inner housing 1960 within a tool 1980 including a first tool half 1980A and a second tool half 1980B. The assembled inner housing 1960 may be placed in first tool half 1980, at least one tooling tab 1968 engaging a corresponding surface 1969. In this manner, inner housing 1960 may be suspended within tool 1980. Second tool half 1980B is placed upon and mechanically connected to first tool half 1980A, at which point a polymer 1910 is injected into the interior of tool 1980, to encapsulate inner housing 1960.

FIGS. 191-19L illustrate a ballistic armor 1900. Ballistic armor 1900 includes a front 1982 and a back 1984. Front 1982 may be a strike face while back 1984 may be a wear face. Apertures 1970 are retained to receive fasteners to mount straps, brackets, or the like to connect a front ballistic armor 1900 to a rear ballistic armor 1900 to cover the front and rear of the user's torso. Apertures 1970 are positioned to connect shoulder straps and waist straps. Shoulder straps and waist straps may be added after the preparation of ballistic armor 1900, and are positioned to pass over the user's shoulders and around the sides of the user's waist, from the front ballistic armor 1900 component to the rear ballistic armor 1900 component.

Front 1982 may include varied thicknesses, patterns, and/or densities of polymer 1910 to assist in the yawing of a projectile striking armor 1900.

Armor 1900 may include a plurality of vent ribs 1958. Vent ribs 1958 may extend vertically. Vent ribs 1958 may provide channels for heat to escape between the remainder of back 1956 and a wearer's body. Vent ribs 1958 may provide channels for air to flow between the remainder of back 1956 and a wearer's body. Vent ribs 1958 may provide additional stiffness to armor 1900.

In one aspect, armor 1900 is customizable to an individual user, not only via the user's selection of projectile resistance in specific critical and non-critical areas to save thickness and weight where possible, but also in that the user's chest and back may be scanned using a 3D scanner to generate a model of the user, after which armor 1900's size, curvature, and the like may be tailored specifically to that user's body. Additionally, or alternatively, armor 1900 may be sized and shaped to accommodate a user's breasts.

While ballistic armor 1800, 1900 described herein is discussed as possibly being used as personal body armor, the same structure and manufacturing method can be used to form ballistic armor 1800, 1900 as vehicle armor, ballistic building panels, and the like. That is, instead of taking the shape of personal body armor, ballistic armor 1800, 1900 could take the shape of a vehicle door or fender, or a building door or wall.

Similarly, where ballistic armor described herein is used to protect a vehicle, thinner ballistic tiles, a single layer of ballistic tiles, and/or less or no layers of an insert may be used in less critical areas to save on thickness and weight of the ballistic armor, while sacrificing some projectile resistance. Likewise, thicker ballistic tiles, multiple layers of ballistic tiles, and/or more layers of an insert may be used in more critical areas to provide a higher level of projectile resistance. This variation of projectile resistances can be included in a single ballistic armor element/panel so as to reduce/eliminate the number of seams within the ballistic protection area.

Any ceramics, ballistic tiles, ballistic sheets, or ballistic foams described herein may include, without limitation: silicon carbide, boron carbide, alumina, silicon nitride, titanium boride, aluminum nitride, silicon aluminum oxynitride, fiber-reinforced ceramics, and ceramic-metal composite materials.

Ceramics, ballistic tiles, ballistic sheets, or ballistic foams described herein act to stop projectiles as a result of the high compressive strength of the ceramics, ballistic tiles, ballistic sheets, or ballistic foams. Encapsulating polymers and/or inserts may act to provide tensile strength to the ballistic armor. Encapsulating polymers and/or inserts may be added to any ballistic armor or ballistic arrays disclosed herein.

Ballistic armor described herein may be used for any of a variety of purposes, including for example, vehicle armor, ballistic helmets, personal body armor, wall panels for occupied dwellings, doors, desks and other furniture, ceiling panels, floor panels, bags and briefcases, and the like.

Any polymers described herein may be used as a structural component for an armored product, in addition to being used as a component in the ballistic armor. For example, the polymers may both contain and constrain the ballistic tiles and act as a structural component such as vehicle frame components, body panels, doors, floor panels, and the like.

Ballistic armor may be made by any of a variety of methods, including preparing a tool having a mold cavity, placing one or more array or sheet of ballistic tiles or ballistic foam within the mold cavity, and injecting a polymer (such as DCPD) into the mold cavity to encapsulate the one or more array or sheet, as well as extending through the array or sheet to ensure continuous polymer extending from the front (strike face) to the rear (back face) of the ballistic armor. The one or more array or sheet may be placed within the mold cavity with standoffs designed to ensure that the array or sheet is held off of the mold face and that a desired thickness of the polymer is on each side of the array or sheet.

DCPD has significant strength and stiffness for its weight. As such, where the polymer is DCPD, or a similarly strong and stiff polymer, the polymer is used not only as a structural component of the ballistic armor, but also as an armor component (e.g., to help slow, yaw, or break up a projectile). Additionally, the polymer can be used to encapsulate ballistic tiles and/or inserts to constrain and contain those elements after being struck by a projectile, to minimize loss of those elements and retain ballistic resistance even where multiple projectiles strike the same localized area. In this manner, the polymer selected can serve a multi-part role beyond simply being used to contain the armor elements.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available or prudent in manufacturing. To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

What is claimed is:

1. A ballistic armor, comprising:
a front and a back;
one or more ballistic tile;
one or more insert between the ballistic tile and the back; and
a polymer encapsulating the one or more ballistic tile and the one or more insert;
wherein one or more mold tab is attached to an edge of one or more ballistic tile.

2. The ballistic armor of claim 1, wherein the one or more mold tab suspends the one or more ballistic tile within a tool during injection of the polymer.

3. The ballistic armor of claim 1, wherein the insert is a textile material.

4. The ballistic armor of claim 1, wherein the insert is a para-aramid synthetic textile material.

5. The ballistic armor of claim 1, wherein the insert is a polyethylene material.

6. The ballistic armor of claim 1, wherein the insert is an ultra-high molecular weight polyethylene material.

7. The ballistic armor of claim 1, wherein the polymer is a dicyclopentadiene resin.

8. The ballistic armor of claim 1, wherein the one or more mold tab includes a plurality of mold tabs arranged around the edge of one or more ballistic tile.

9. The ballistic armor of claim 1, further comprising a supplemental layer between the one or more ballistic tile and the front.

10. The ballistic armor of claim 1, wherein the back includes vent ribs.

11. A ballistic armor, comprising:
a front and a back;
an inner housing formed from a polymer,
wherein the inner housing includes one or more tooling tab;
one or more ballistic tile mounted to a mounting area of the inner housing between the inner housing and the front;
one or more insert mounted to the inner housing between the inner housing and the back; and
a polymer encapsulating the one or more ballistic tile and the one or more insert.

12. The ballistic armor of claim 11, wherein the one or more tooling tab suspends the inner housing within a tool during injection of the polymer.

13. The ballistic armor of claim 11, wherein the insert is a textile material.

14. The ballistic armor of claim 11, wherein the insert is a para-aramid synthetic textile material.

15. The ballistic armor of claim 11, wherein the insert is a polyethylene material.

16. The ballistic armor of claim 11, wherein the insert is an ultra-high molecular weight polyethylene material.

17. The ballistic armor of claim 11, wherein the polymer is a dicyclopentadiene resin.

18. The ballistic armor of claim 11, wherein the one or more tooling tab includes a fastener aperture.

19. The ballistic armor of claim 1, wherein the back includes vent ribs.

20. The ballistic armor of claim 1, wherein the inner housing includes a plurality of mounting areas, and wherein a ballistic resistance of the one or more ballistic tile of at least one of the mounting areas is less than a ballistic resistance of the one or more ballistic tile of at least another of the mounting areas.
